(19) United States
(12) Patent Application Publication
(10) Pub. No.: US 2008/0065658 A1
(43) Pub. Date: Mar. 13, 2008

(54) Method and system for developing geographic information web service framework

(76) Inventors: Puneet Sharma, Noida (IN); Mudit Kumar Bohra, Delhi (IN)

Correspondence Address: Puneet Sharma, RMSI Private Limited, A-7, Sector 16, Noida, 201301, IN

(21) Appl. No.: 11/892,359

(22) Filed: Aug. 22, 2007

(30) Foreign Application Priority Data
Aug. 24, 2006 (IN) 1906/DEL/2006

(51) Int. Cl. G06F 7/00

(52) U.S. Cl. 707/100

(57) ABSTRACT

A method, a system and a computer program product developing a Geographic Information System (GIS) web service framework for a user is provided. The method includes developing the GIS web service framework using a database that comprises spatial data. Further, the GIS web service framework provides a GIS web service to the user. A GIS function is incorporated with the GIS web service. The user accesses the GIS function using this GIS web service.

### FIELD OF INVENTION

Embodiments of the invention relate, in general, to geographic information systems and more specifically, the embodiments of the invention relate to methods and systems for developing a geographic information system web service framework.

A database is a collection of data that is organized so that the data can be easily stored, accessed and managed. The database can be classified based on type of the stored data. For example, a database can be classified based on the type of the data such as bibliographic information, image data or spatial data etc. A user with requisite access rights can access the database to retrieve information stored in the database

The database that stores spatial data is known as a spatial database. The spatial data provides information pertaining to the location, the shape, and the description of geographical features. The spatial database stores this spatial data in a prescribed format that includes the location, the shape, and the description of the geographical features as well as the relationships between different geographical features. For example, the spatial database is an Oracle Spatial Database 8i from Oracle, Inc.

The spatial database is integrated with spatial functionalities for the spatial data. For example, a database can be an Oracle database that has inbuilt spatial functionalities available in the form of SQL accessed procedures. The spatial functionalities allow manipulation of geographic attributes of the spatial data. Generally, the spatial functionalities are present at an application server. The application server is a middle tier application between the user and the database. Moreover, the application server utilizes the data stored in the database. For example, the application server is an Oracle Application Server of Oracle database 9i from Oracle, Inc.

Further, the spatial database is used by Geographical Information Systems (GIS) to display the spatial data. The GIS is a computer system that is capable of assembling, storing, manipulating, and displaying geographically referenced information associated with the spatial data. For example, the GIS are used by a user to display maps for online route selection, environmental exploration, and land use planning.

According to one conventional technique, a third party GIS software is configured to access a spatial database and present the spatial data to a user. However, the use of the third party GIS software incurs additional cost to the user. In addition, there can be interoperability issues between various third party GIS software providers.

According to another conventional technique, a spatial database has inbuilt functions that can be configured with the spatial data. However, a user has to configure the inbuilt functions every time for implementing GIS applications on the spatial data. Moreover, the user requires sufficient programming skills in order to configure the inbuilt spatial database functions for further use.

### BRIEF DESCRIPTION OF THE DRAWINGS

The present invention is illustrated by way of an example and is not limited by the example and/or in the accompanying drawings, in which like references indicate similar elements and in which:

FIG. 1 illustrates a network environment wherein an exemplary embodiment of the invention can be practiced.

FIG. 2 is a flowchart depicting the requisite steps taken for developing a Geographic Information System (GIS) web service framework for a user, in accordance with an exemplary embodiment of the invention.

FIG. 3 is a flowchart depicting the requisite steps taken for accessing a Geographic Information System (GIS) web service in a GIS web service framework, in accordance with an exemplary embodiment of the invention.

FIGS. 4a and 4b describes a flowchart for accessing a GIS function using a GIS web service in a GIS web service framework, in accordance with an example of the invention.

### DETAILED DESCRIPTION OF EMBODIMENTS OF THE INVENTION

The preferred embodiments of the invention have been described in the following description and it will be clear that the invention is not limited to these embodiments only. Numerous specific details are set forth in order to provide a thorough understanding of the embodiments of the present invention. It will be evident that modifications, changes, variations, substitutions and equivalents will be apparent to those skilled in the art without departing from the spirit and scope of the invention as described in the appended claims.

The embodiments of the invention provide a method, a system, and a computer-readable medium for developing a Geographic Information System (GIS) web service framework. The various embodiments of the invention provide a method for developing the GIS web service framework to provide an access for a GIS web service. The GIS web service framework is developed using a database that stores spatial data. The GIS web service framework provides the GIS web service to a user. The GIS web service is a software application that consumes spatial functionalities that are associated with the database to provide GIS solutions. The various embodiments of the invention provide a method to access the GIS web service in the GIS web service framework. The user invokes the GIS web service for a GIS function. The GIS function is associated with the spatial data of the database. The GIS function helps in providing GIS solutions to the user. Moreover, the GIS function is created using the spatial functionalities that are associated with the spatial data. Further, the GIS function is incorporated with the GIS web service and stored on an application server. This GIS web service provides with a set of re-usable GIS functions to the user. Further, the user invokes the GIS web service containing the GIS function from the application server. This minimizes the need of separate third party GIS software for the user.

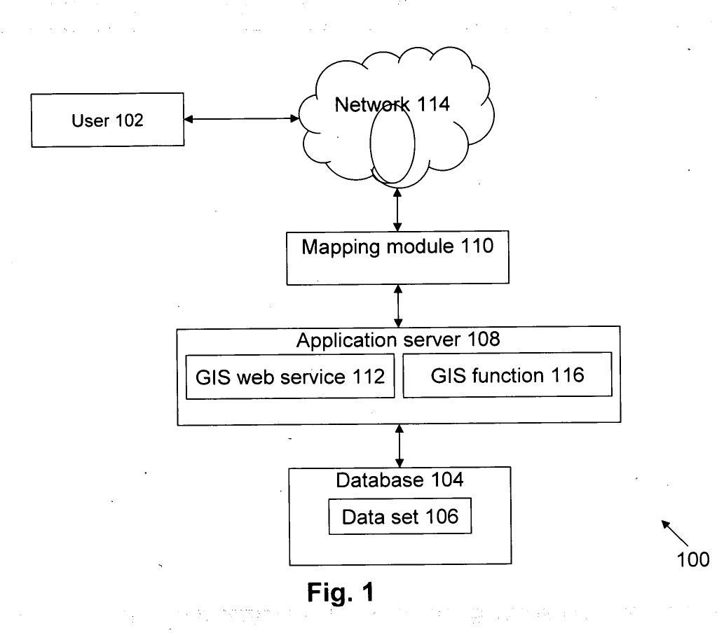

FIG. 1 illustrates a network environment 100 wherein an exemplary embodiment of the invention can be practiced. Network environment 100 includes a user 102, a database 104 comprising a data set 106, an application server 108 and a mapping module 110. According to various embodiments of the invention, data set 106 is spatial data that provides information pertaining to locations, shapes, and descriptions of geographical features. Data set 106 is stored, accessed and managed in database 104. Examples of database 104 include, but are not limited to Oracle database 8i, Oracle database 9i, Oracle database 10g and the like. (ORACLE is a registered trademark of Oracle International Corporation of Redwood City, Calif.)

According to various embodiments of the invention, database 104 is configured with application server 108. Application server 108 is a system server comprising application software that utilizes data set 106 of database 104 for various applications. For example, application server 108 is an Oracle application server that provides programming capabilities such as Oracle mapping libraries associated with database 104 such as an Oracle database version 10g.

Further, the application software can be programmed to perform customized applications using application server 108. The application software is programmed to respond to requests, perform logic and manage data. Application server 108 can host various software programs to mange data set 106 that is stored in database 104. In addition, application server 108 acts as a middleware between user 102 and database 104. Application server 108 provides a common interface and acts as an application for exchange of information between user 102 and database 104. Examples of application server 108 are, but not limited to, an oracle application server 10g, an oracle container for java Oc4j, an Apache Tomcat, and any JSP/servelet compatible application.

According to various embodiments of the invention, application server 108 can include mapping module 110. Mapping module 110 is a software program that can map the programming capabilities of application server 108 with various functionalities associated with database 104. For example, mapping module 110 is a software program that resides on application server 108 such as an Oracle application server. Further, mapping module 110 can be configured using Oracle Mapping libraries of the Oracle application server and utilizes the spatial functionalities provided by Oracle database.

In an alternate embodiment of the invention, mapping module 110 can be integrated with user 102. For example, mapping module 110 is a system software program configured with a computer associated with user 102. In yet another embodiment of the invention, mapping module 110 can be integrated with database 104.

Moreover, according to various embodiments of the invention, mapping module 110 can incorporate an administration module. The administration module is a software module that manages access for services provided by application server 108. For example, the administration module specifies a time duration such as a start time and an end time for user 102 for accessing data set 106 that is stored in database 104. The administration module administers functioning of the application software that is hosted on application server 108.

Further, application server 108 can provide the infrastructure to host other server-based systems that can intercommunicate with each other using web services. According to various embodiments of the invention, application server 108 includes a GIS web service 112. GIS web service 112 is a web-based software application that dynamically interacts with other web-based applications. For example, GIS web service is an XML web service. Moreover, GIS web service 112 provides interoperability between applications using open standards such as an eXtensible Markup Language (XML), a Universal Description, Discovery and Integration (UDDI) and a Simple Object Access Protocol (SOAP).

User 102 makes a GIS web request for accessing GIS web service 112 over a network 114. GIS web service 112 provides a mechanism for user 102 to access customized or prepackaged applications that are running on application server 108. For example, user 102 makes an XML based web request using a HTTP to application server 108 for accessing a geographical function such as zoom function associated with data set 106.

According to various embodiments of the invention, GIS web service 112 can act as an interface between database 104 and a web application of the user. This interface describes various services that can be provided by web service 112. Further, GIS web service 112 encapsulates the spatial functionalities and the procedures that are provided by database 104.The user can invoke GIS web service 112 using a proxy client. In addition, GIS web service 112 provides a mechanism using which the user does not require a specific platform or programming languages for implementing functionalities of the application software that is associated with application server 108.

Further, the administration module allows user 102 to define styles for GIS web service 112. The styles are visual attributes used to represent the spatial functionalities that are associated with data set 106. User 102 applies these styles for various customized GIS applications such as map rendering with limited GIS functionalities. For example, an organization purchases a license for a limited set of GIS functionalities. Thereafter, the administration module is configured for providing only the limited set of GIS functionalities to the organization. Moreover, the administration module administers functioning of GIS web service 112. For example, the administration module can store a schema of users that are accessing GIS web service 112. This schema is stored in a file of the administration module such as an ‘admin properties file’ of the administration module. Thereafter, the administration module provides access rights for the users based on a rights table that is stored in the administration module. The rights table contains information of the users and the corresponding access rights assigned to them.

According to various embodiments of the invention, mapping module 110 can incorporate the administration module with GIS web service 112. In an alternate embodiment of the invention, the administration module can be incorporated with application server 108. In yet another embodiment of the invention, the administration module can be integrated with a computer associated with user 102. Further, user 102 makes the GIS web request over a network 114 that provides a communication path for exchange of information between user 102 and application server 108. According to various embodiments of the invention, network 114 can be Internet, Intranet or a combination of both. For example, user 102 makes a Hypertext Transfer Protocol (HTTP) request over Internet for GIS web service 112. In another example, user 102 makes the GIS web request using a computer over Local Area Network (LAN). Further, connections used for network 114 can be wired or wireless or a combination of both.

According to various embodiments of the invention, user 102 makes a GIS web request for GIS web service 112 to access a GIS function 116. GIS function 116 is associated with attributes and spatial aspects of data set 106. Examples of GIS function 116 include, but are not limited to, zoom in for data set 106, zoom out for data set 106, drag pan for data set 106, map legends for data set 106 and the like.

Further, mapping module 110 creates GIS function 116 based on the spatial functionalities provided by application server 108. The spatial functionalities are associated with database 104. Example of the spatial functionalities include, but are not limited to, Geocoding, Georaster support, network and topology data models, spatial analysis functions and the like.

According to various embodiments of the invention, application server 108 provides these spatial functionalities for use in various GIS applications. For example, the spatial functionalities such as Geocoding is used for assigning geographic coordinates such as latitude to street addressable features and are accessed using other GIS applications.

According to various embodiments of the invention, mapping module 110 maps GIS function 116 with GIS web service 112. Further, GIS function 116 is implemented using GIS web service 112. For example, GIS function 116 such as map zoom can be implemented by invoking GIS web service 112 such as a J2EE based XML web service for zooming. Further, GIS function 116 can be used to develop the GIS web service framework to provide GIS solutions. According to one embodiment of the invention, the GIS web service framework can be a client-server application. In another embodiment of the invention, the GIS web service framework can be a web-enabled framework. In yet another embodiment of the invention, the GIS web service framework can be an Application Server Provider (ASP) framework. Moreover, the GIS solutions provided by GIS web service framework are interoperable between various software platforms such as Java platforms, .NET platforms.

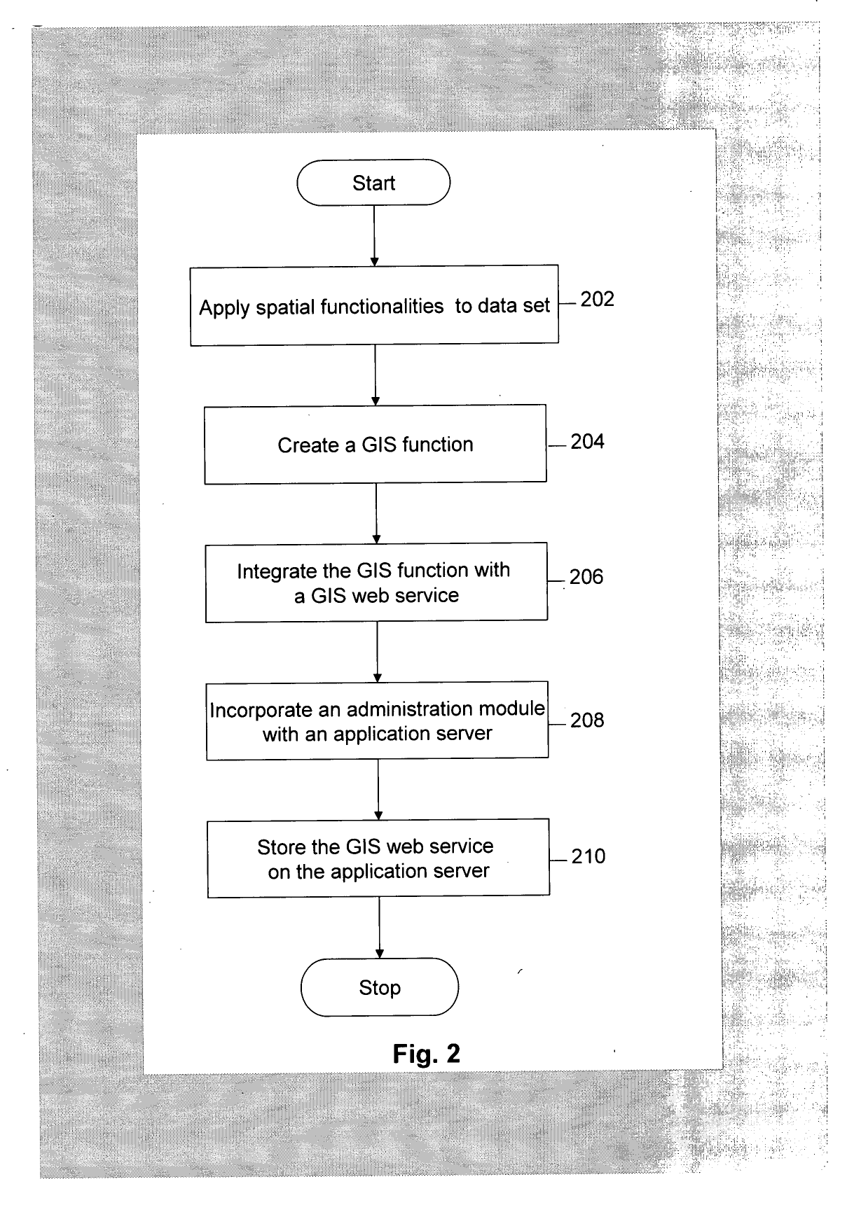

FIG. 2 is a flowchart depicting the requisite steps taken to develop the GIS web service framework, in accordance with an exemplary embodiment of the invention. At step 202, mapping module 110 applies the spatial functionalities to data set 106. Moreover, mapping module 110 uses the spatial functionalities along with various other features such as linear referencing systems, topologies, spatial analysis, available with database 104 for creating GIS function 116. For example, mapping module 110 develops a mapping solution by packing spatial functionalities provided by Oracle mapping libraries along with features such as inbuilt spatial procedures for creating GIS function 116.

Further, at step 204, GIS function 116 is created. According to various embodiments of invention, mapping module 110 creates GIS function 116. Mapping module 110 creates GIS function 116 that can be invoked using GIS web service 112. Details pertaining to mapping module 110 have been provided with reference to FIG. 1. At step 206, GIS function 116 is incorporated with GIS web service 112. According to various embodiments of invention, mapping module 110 incorporates GIS function 116 with GIS web service 112. Moreover, GIS web service 112 incorporates GIS function 116 for querying database 104 for data set 106. In another embodiment of the invention, application server 108 configures GIS function 116 with GIS web service 112. Thereafter, GIS function 116 can be accessed by invoking for GIS web service 112. For example, GIS function 116 is a direction pan function for a map. The direction pan function provides the direction of the movement and the scale by which the map is to be panned. Thereafter, user 102 makes the GIS web request for GIS web service 112 that is configured with GIS function 116. The GIS web request invokes GIS web service 112.

At step 208, the administration module is incorporated with application server 108 for managing access rights for GIS web service 112. According to various embodiments of the invention, the administration module validates access rights of user 102. For example, the administration module validates a password assigned to user 102. Moreover, the administration module issues a token for a session to user 102. This token provides user 102 with access rights for GIS web service 112. According to various embodiments of the invention, the administration module can provide the access rights for GIS web service 112. In another embodiment of the invention, the administration module can define a set of user groups that has access for GIS web service 112. In another embodiment of the invention, the administration module can define various roles for user 102. For example, the administration module can provide user 102 exclusive rights for modification of data set 106.

At step 210, GIS web service 112 is stored on application server 108. According to various embodiments of invention, mapping module 110 stores GIS web service 112 on application server 108. For example, mapping module 110 can store a Uniform Resource Locator (URL) for a GIS web service request. This URL provides access to GIS function 116. User 102 can request this URL over Internet for accessing GIS function 116. In this way, user 102 can access GIS function 116 directly over Internet.

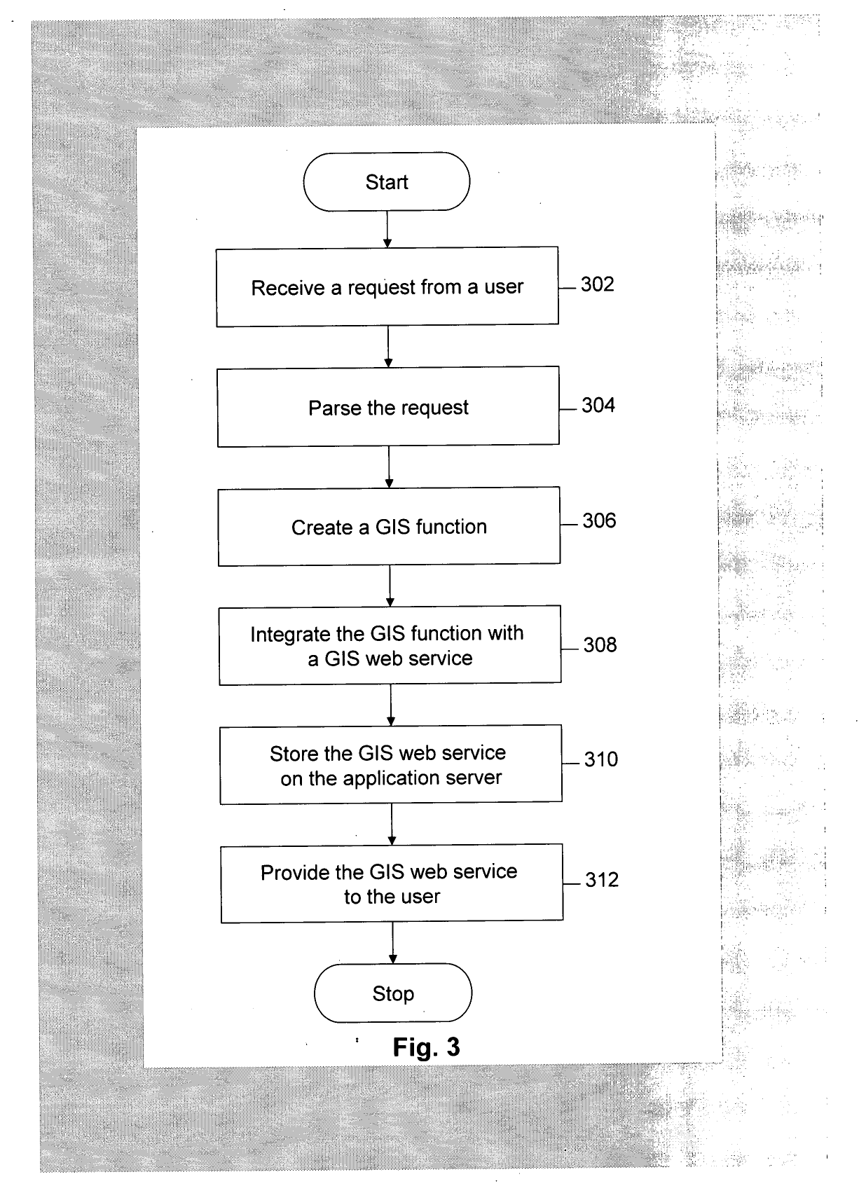

FIG. 3 is a flowchart depicting the requisite steps taken to access GIS web service 112 in the GIS web service framework, in accordance with an exemplary embodiment of the invention. At step 302, user 102 makes a GIS web request for accessing GIS web service 112. According to various embodiments of the invention, user 102 makes the GIS web request to mapping module 110 over network 114. For example, user 102 creates an XML request using a web browser and sends the XML request using a HTTP over network 114. Details pertaining to network 114 have been explained in reference to FIG. 1.

Further, at step 304, mapping module 110 parses the GIS web request. Mapping module 110 parses the GIS web request to determine the requested GIS function 116. Moreover, mapping module 110 can determine the validity of the GIS web request during parsing of the GIS web request. For example, user 102 makes a GIS web request to invoke GIS web service 112 for accessing GIS function 116 such as a direction pan function. Thereafter, mapping module 110 parses this GIS web request to determine the validity of the GIS web request. Mapping module 110 validates keywords in the GIS web request. For example, mapping module 110 validates the keywords against pre-stored keywords for the direction pan function such as ‘north’, ‘south’, ‘east’, ‘west’, ‘north-east’, ‘south west’ etc. According to various embodiments of the invention, mapping module 110 can include a parser that parses the GIS web request. For example, mapping module 110 includes an XML parser that parses an XML request.

At step 306, GIS function 116 is created. At step 308, GIS function 116 is integrated with GIS web service 112. At step 310, GIS web service 112 is stored on application server 108. Details pertaining to step 306, step 308 and step 310 have been provided with reference to FIG. 2.

Further at step 312, a GIS web response for GIS web service 112 is provided to user 102. According to various embodiments of the invention, mapping module 110 provides the GIS web response for GIS web service 112 to user 102. For example, mapping module 110 provides an XML response to user 102. The XML response may contain an URL for GIS web service 112 such as the URL of a requested map image. In an alternate embodiment of the invention, application server 108 can provide the GIS web response to user 102.

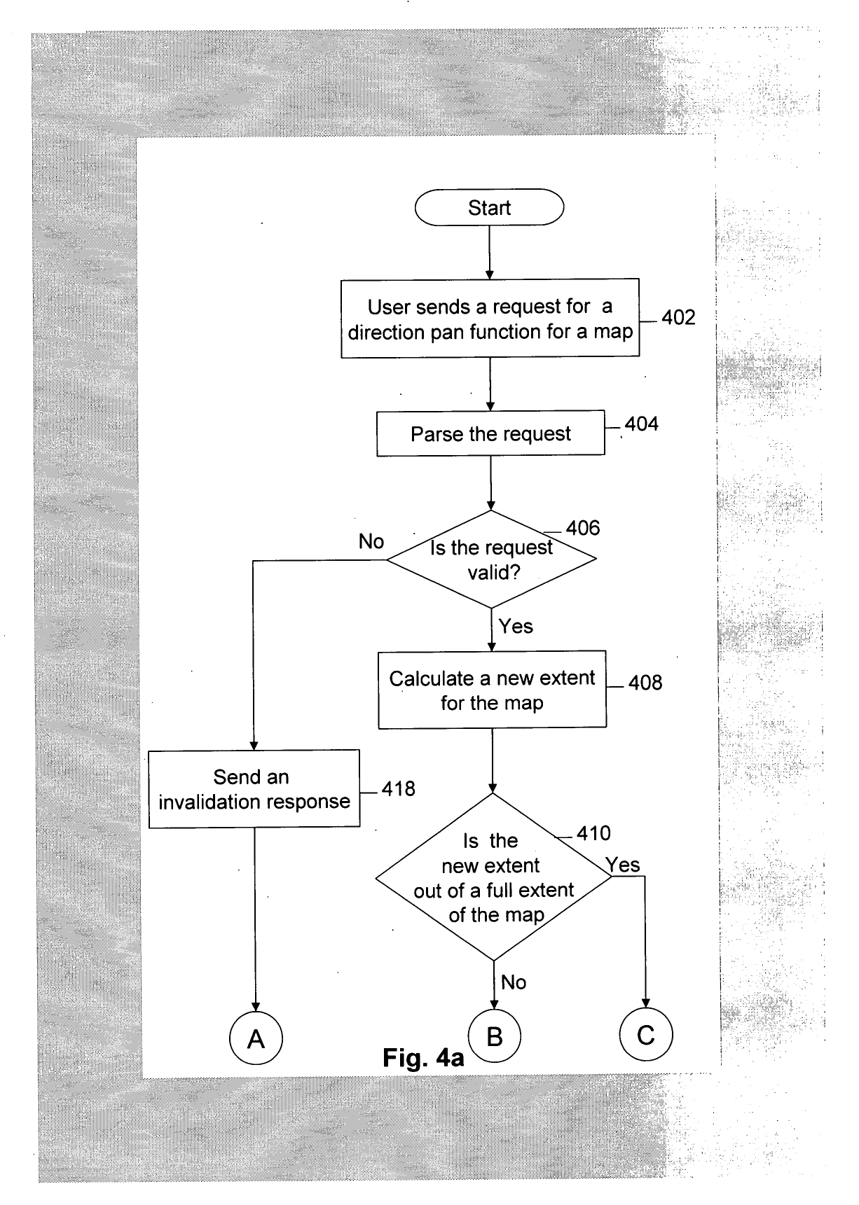

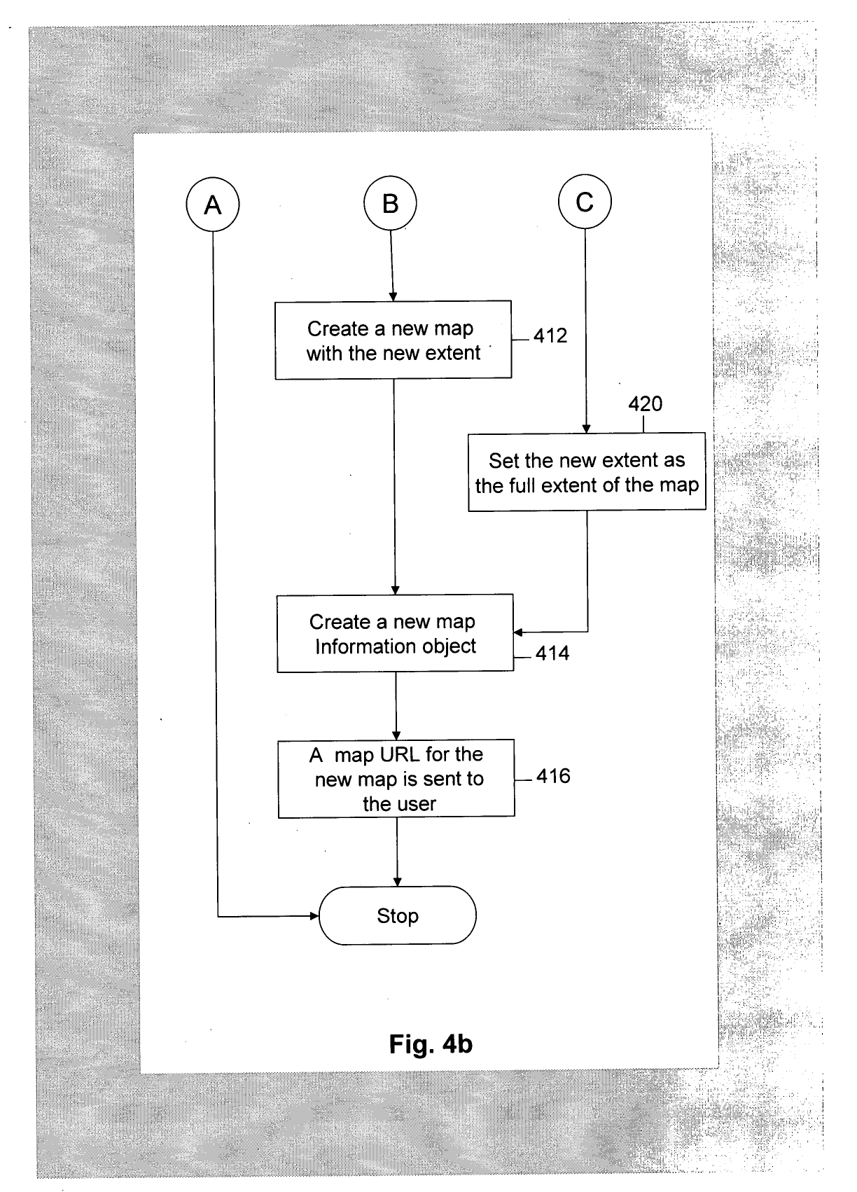

FIG. 4 is a flowchart depicting the requisite steps taken to for accessing GIS function 116 such as a direction pan function using GIS web service 112 in the GIS web service framework, in accordance with an example for the invention. The example describes steps for accessing the direction pan function through Java server pages on a map associated with Oracle 10g database. According to the example, the map is representation of data set 106 on a planner surface.

At step 402, user 102 makes a GIS web request for the direction pan function for the map. The GIS web request provides keywords that are associated with direction of navigation of the map and a scale for navigation. The scale is a factor for the navigation based on the extent of the map. Further, the extent of the map is cumulative 2d limits of the spatial data in X and Y coordinates.

An example format of the GIS web request is ‘pan (param, direction, factor, token)’. The ‘param’ in the example format indicates attributes of the map such as height, width, bounds etc. The ‘direction’ in the example format indicates a keyword for the direction pan function. The keyword indicates the direction such as north, south, east, west etc. for the map. The ‘factor’ in the example format indicates the scale for the direction pan function. Further, the ‘token’ in the example format indicates that user 102 has been authenticated. According to the example, mapping module 110 authenticates user 102. Details pertaining to authentication have been explained in reference to FIG. 1.

Further, the map is accessed using a computer associated with user 102. The computer provides the interface to user 102 for accessing GIS web service 112. The computer is in communication with the Oracle 10g database. User 102 can click on the map for making the GIS web request. This GIS web request invokes GIS web service 112. At step 404, the GIS web request is parsed. The GIS web request is parsed using mapping module 110 that is associated with Oracle application server of the Oracle 10g database. Details pertaining to the parsing of the GIS web request have been explained with reference to FIG. 3.

At step 406, the GIS web request is validated using Oracle application server. According to the example, mapping module 110 validates the keywords in the GIS web request against pre-stored keywords associated for the direction pan function. Examples of the pre-stored keywords are ‘north’, ‘south’, ‘east’, ‘west’, ‘north-east’, ‘south west’ etc. At step 408, mapping module 110 calculates a new extent for the map based on the keywords and the scale. The new extent for the map is used for creating a new map. The new map indicates the map with GIS function 116 applied on the map. Further, at step 410, it is checked that the new extent of the map is out of the extent of the map. This is useful in fixing a limit for the extent of the map.

At step 412, the new map is created using the new extent if the new extent of the map is not out of the extent of the map. According to the example, mapping module 110 creates the new map. The new map is created based on the keywords and the scale. According to the example, mapping module 110 can utilize programming capabilities provided by application server 108 to create the new map. At step 414, a new map extent information object is created. The new map extent information object contains information about the new map like current scale, extents, layers present in the map, legend URL if any, affine transformation parameters etc. At step 416, a map URL for the new map is provided to user 102. According to the example, mapping module 110 provides the map URL to user 102. An example of the map URL is ‘http://[application name]/[ouput file name].[output file format]’. The ‘application name’ in the example indicates a web application that invokes GIS web service 112 internally. The ‘output file name’ in the example indicates a name by which the new map is created. The ‘[output file format]’ in the example indicates a file format of the new map. Further, user 102 displays the new map on the computer by accessing an URL over the Internet. This URL is associated with the map URL.For example, the URL can be ‘http://HDNSname/ApplicationName/11046756.png’

Further, at step 406, if the GIS web request is invalidated then step 418 is performed. At step 418, mapping module 110 sends an invalidation response to user 102. The invalidation response indicates that the keywords are different from the pre-stored keywords. Thereafter, an error is displayed on the computer of user 102.

Further, at step 410, if the new extent of the map is out of the extent of the map, then step 420 is performed. At step 420, the new extent is set to the extent of the map. Thereafter, step 412, step 414 and step 416 are performed.

Embodiments of the present invention have the advantage that the need of integrating third party GIS software products is minimized. The GIS web services are ready to use web services that can be directly accessed using a web browser over Internet. Moreover, the GIS web services can also be accessed directly using enterprise computers over Intranet. This also reduces the total cost of operation for providing GIS solutions. Further, the GIS web services are based on open standards. This makes the GIS web services interoperable between various GIS software products. In addition to this, the GIS web services are integrated with a database system. This makes use of a single vendor for a database provider and a GIS solutions provider. The GIS web services can be deployed on multiple platforms such as Microsoft Windows, Linux, UNIX and the like. The GIS web service framework also incorporates an administration module that provides enhanced capabilities such as security, management, access rights, creation of user groups, defining of user roles etc. Further, GIS web services can provide multilingual solutions.

Although the invention has been described using a few embodiments herein, it is understood that these embodiments are merely illustrative, and not restrictive, of the present invention. Numerous changes and modifications in the invention as known to those skilled in the art could be made to the embodiment of the present invention without departing from the scope and spirit of the invention as set forth. Therefore, it will be appreciated that the present invention is not to be limited to the details shown and described herein, but the present invention is intend to cover all such changes and modifications as encompassed by the scope of the appended claims.

I/we claim:

1. A method for developing a Geographic Information System (GIS) web service framework for a user, the GIS web service framework is developed using a database, the database comprises spatial data, the GIS web service framework provides a GIS web service to the user, the GIS web service is based on spatial functionalities associated with the database, the GIS web service provides a GIS function for the spatial data, the method comprising:
a. creating a GIS function, wherein the GIS function is created by applying the spatial functionalities to the spatial data;
b. incorporating the GIS function with the GIS web service; and
c. storing the GIS web service on an application server.

2. The method of claim 1, wherein the step of developing the GIS web service framework further comprises:
a. incorporating an administration module with the GIS web service framework, wherein the administration module manages access to the GIS web service.

3. The method of claim 1, wherein the GIS web service framework is a web based framework.

4. The method of claim 1, wherein the GIS web service framework is a Client-Server based framework.

5. The method of claim 1, wherein the database is Oracle database.

6. The method of claim 1, wherein the GIS web service is an XML web service.

7. The method of claim 1, wherein the application server is Oracle application server.

8. A method for accessing a Geographic Information System (GIS) web service in a GIS web service framework, the GIS web service framework comprises a database, the database comprises spatial data, the GIS web service is based on spatial functionalities associated with the database, the method comprising:
a. receiving a GIS web request to access the GIS web service from a user;
b. processing the GIS web request using the spatial functionalities, wherein the step of processing the GIS web request comprises the steps of:
i. creating a GIS function, wherein the GIS function is created by applying the spatial functionalities to the spatial data;
ii. incorporating the GIS function with the GIS web service; and
iii. storing the GIS web service on an application server; and
c. providing a GIS web response for the GIS web service to the user.

9. The method of claim 8, wherein the processing the GIS web request further comprises:
a. parsing the GIS web request.

10. A system for developing a Geographic Information System (GIS) web service framework for a user, the GIS web service framework is developed using a database, the database comprises spatial data, the GIS web service framework provides a GIS web service to the user, the GIS web service is based on spatial functionalities associated with the database, the GIS web service provides a GIS function for the spatial data, the system comprising:
a. means for creating a GIS function, wherein the GIS function is created by applying the spatial functionalities to the spatial data;
b. means for incorporating the GIS function with the GIS web service; and
c. means for storing the GIS web service on an application server.

11. A computer program product for use in conjunction with a computer system, the computer program product comprising a computer readable storage medium, the computer readable storage medium stores instructions that are executable on a computer processor for developing a Geographic Information System (GIS) web service framework for a user, the GIS web service framework is developed using a database, the database comprises spatial data, the GIS web service framework provides a GIS web service to the user, the GIS web service is based on spatial functionalities associated with the database, the GIS web service provides a GIS function for the spatial data, the instructions comprising:
a. creating a GIS function, wherein the GIS function is created by applying the spatial functionalities to the spatial data;
b. incorporating the GIS function with the GIS web service; and
c. storing the GIS web service on an application server.
